(19) United States
(12) Patent Application Publication
(10) Pub. No.: US 2012/0096451 A1
(43) Pub. Date: Apr. 19, 2012

(54) FIRMWARE UPDATE IN A MEDICAL DEVICE WITH MULTIPLE PROCESSORS

(75) Inventors: James D. Tenbarge, Fishers, IN (US); Robert Timmerman, Fishers, IN (US); Mark Nierzwick, Brownsburg, IN (US); Robert E. Reinke, Indianapolis, IN (US); Daniel Birtwhistle, Fishers, IN (US); James R. Long, Fishers, IN (US); Robert P. Sabo, Indianapolis, IN (US); Phillip E. Pash, Indianapolis, IN (US); D. Bradley Markinsohn, Indianapolis, IN (US)

(73) Assignee: ROCHE DIAGNOSTICS OPERATIONS, INC., Indianapolis, IN (US)

(21) Appl. No.: 12/905,498

(22) Filed: Oct. 15, 2010

(51) Int. Cl. G06F 9/44

(52) U.S. Cl. 717/170

(57) ABSTRACT

The present disclosure describes a handheld diabetes management device that implements a failsafe firmware upgrading protocol to reduce required user interaction and risk of device downtime. The general processing module executes first software from nonvolatile memory. The general processing module receives second software from an external port and writes the second software to the nonvolatile memory. Based on an upgrade signal, the general processing module switches execution from the first software to the second software, evaluates proper operation of the general processing module, and switches execution back to the first software from the second software when proper operation of the general processing module using the second software is not detected. A communications module, in electrical communication with the general processing module, stores third software and executes the third software. The general processing module receives fourth software from the external port and replaces the third software with the fourth software.

### FIELD

The present disclosure relates generally to handheld medical devices and more particularly to updating firmware and application data in handheld diabetes management devices having multiple processors.

### BACKGROUND

There is a need for a handheld diabetes management device that can be updated in the field without requiring special expertise and without risking impairment of the device's functionality. Often referred to just as diabetes, diabetes mellitus is a chronic condition in which a person has elevated blood glucose levels that result from defects in the body's ability to produce and/or use insulin. There are three main types of diabetes. Type 1 diabetes usually strikes children and young adults, and can be autoimmune, genetic, and/or environmental. Type 2 diabetes accounts for 90-95% of diabetes cases and is linked to obesity and physical inactivity. Gestational diabetes is a form of glucose intolerance diagnosed during pregnancy and usually resolves spontaneously after delivery.

In 2009, according to the World Health Organization, at least 220 million people worldwide suffer from diabetes. In 2005, an estimated 1.1 million people died from diabetes. Its incidence is increasing rapidly, and it is estimated that between 2005 and 2030, the number of deaths from diabetes will double. In the United States, nearly 24 million Americans have diabetes, with an estimated 25 percent of seniors age 60 and older being affected. The Centers for Disease Control and Prevention forecast that 1 in 3 Americans born after 2000 will develop diabetes during their lifetime. The National Diabetes Information Clearinghouse estimates that diabetes costs $132 billion in the United States alone every year. Without treatment, diabetes can lead to severe complications such as heart disease, stroke, blindness, kidney failure, amputations, and death related to pneumonia and flu.

Diabetes is managed primarily by controlling the level of glucose in the bloodstream. This level is dynamic and complex, and is affected by multiple factors including the amount and type of food consumed, and the amount of insulin (which mediates transport of glucose across cell membranes) in the blood. Blood glucose levels are also sensitive to exercise, sleep, stress, smoking, travel, illness, menses, and other psychological and lifestyle factors unique to individual patients. The dynamic nature of blood glucose and insulin, and all other factors affecting blood glucose, often require a person with diabetes to forecast blood glucose levels. Therefore, therapy in the form of insulin or oral medications, or both, can be timed to maintain blood glucose levels in an appropriate range.

Management of diabetes is time-consuming for patients because of the need to consistently obtain reliable diagnostic information, follow prescribed therapy, and manage lifestyle on a daily basis. Diagnostic information, such blood glucose, is typically obtained from a capillary blood sample with a lancing device and is then measured with a handheld blood glucose meter. Interstitial glucose levels may be obtained from a continuous glucose sensor worn on the body. Prescribed therapies may include insulin, oral medications, or both. Insulin can be delivered with a syringe, an ambulatory infusion pump, or a combination of both. With insulin therapy, determining the amount of insulin to be injected can require forecasting meal composition of fat, carbohydrates and proteins along with effects of exercise or other physiologic states. The management of lifestyle factors such as body weight, diet, and exercise can significantly influence the type and effectiveness of a therapy.

Management of diabetes involves large amounts of diagnostic data and prescriptive data acquired in a variety of ways: from medical devices, from personal healthcare devices, from patient-recorded logs, from laboratory tests, and from healthcare professional recommendations. Medical devices include patient-owned bG meters, continuous glucose monitors, ambulatory insulin infusion pumps, diabetes analysis software, and diabetes device configuration software. Each of these systems generates and/or manages large amounts of diagnostic and prescriptive data. Personal healthcare devices include weight scales, blood pressure cuffs, exercise machines, thermometers, and weight management software. Patient recorded logs include information relating to meals, exercise and lifestyle. Lab test results include HbA1C, cholesterol, triglycerides, and glucose tolerance. Healthcare professional recommendations include prescriptions, diets, test plans, and other information relating to the patient's treatment.

There is a need for a handheld patient device to aggregate, manipulate, manage, present, and communicate diagnostic data and prescriptive data from medical devices, personal healthcare devices, patient recorded information, biomarker information, and recorded information in an efficient manner to improve the care and health of a person with diabetes, so the person with diabetes can lead a full life and reduce the risk of complications from diabetes.

Consequently, there is a need for a handheld patient device that offers connectivity with a wide range of other devices, including healthcare devices, computers, consumer electronics, and accessories. There exists a need for a handheld patient device that serves as a hub for a patient's diabetes management, from glucose monitoring to insulin infusion to historical tracking. There exists a need for such a handheld patient device so that patients and clinicians will have more information to monitor and manage diabetes, thereby making diabetes management less intrusive and more appealing to the patient.

Consequently, there is a need for a handheld patient device that can be upgraded, both to add new features and improve patient interfaces, and to implement required improvements, such as regulatory requirements, business rule updates, and fixes. In order to reduce the burden on doctors' offices and to be more convenient for patients, there is a need for a handheld patient device that can be upgraded without requiring a clinic visit. However, there is a need for the upgrade process to require little or no computer expertise. Especially for upgrades that will not be performed at a clinic, there is a need for the upgrade process to be reliable so as to avoid compromising the function of the handheld patient device.

### SUMMARY

The present disclosure describes a handheld diabetes management device that implements a failsafe firmware upgrading protocol to reduce risk of device downtime and to reduce required user interaction. The handheld diabetes management device includes a nonvolatile memory and a general processing module in electrical communication with the nonvolatile memory. The general processing module executes first software from the nonvolatile memory. An external port is in electrical communication with the general processing module. The general processing module receives second software from the external port and writes the second software to the nonvolatile memory.

Based on an upgrade signal, the general processing module switches execution from the first software to the second software, evaluates proper operation of the general processing module, and switches execution back to the first software from the second software when proper operation of the general processing module using the second software is not detected. A communications module, in electrical communication with the general processing module, stores third software and executes the third software. The general processing module receives fourth software from the external port and replaces the third software with the fourth software.

A method is defined for operating a handheld diabetes management device to implement a failsafe firmware upgrading protocol to maximize availability. The method includes storing first software in a nonvolatile memory, receiving second software from an external port, writing the second software to the nonvolatile memory, and selectively receiving an upgrade signal. Based on the upgrade signal, the method switches execution from the first software to the second software, evaluates proper operation of the second software, and switches execution back to the first software from the second software when proper operation of second software is not detected. The method further includes receiving third software from the external port and replacing fourth software of a communications module with the third software.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a patient and a treating clinician;

FIG. 2 shows a patient with a continuous glucose monitor (CGM), an ambulatory insulin infusion pump, and a handheld diabetes management device;

FIG. 3 shows a diabetes management system used by patients and clinicians to manage diabetes;

FIG. 4 is a functional block diagram of an example implementation of a handheld diabetes management device;

FIG. 5 is a flowchart depicting an overview of example firmware upgrading operation; and

FIGS. 6A-6E are flowcharts depicting example operation of portions of the firmware upgrading of FIG. 5.

### DETAILED DESCRIPTION

Systems and methods according to the present disclosure offer a failsafe firmware upgrading protocol. The protocol retains previous versions of firmware so that if new versions fail to work correctly, operation can revert to the previous versions. In addition, the entire firmware of each processor or module is upgraded at once to avoid errors in integrating new upgrades with old software. Further, the present disclosure describes backing up user information from the device, and then adding the user information into newly created databases. This allows new and improved database structures to be defined without orphaning previous data. This also ensures that, at each upgrade, the databases are properly structured, and cumulative data and/or format corruption is avoided. One processor can serve as the central hub, and may write software to additional processors. In fact, the one processor can use one of the other processors as a pass-through to program one or more additional processors.

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical OR. It should be understood that steps within a method can be executed in different order without altering the principles of the present disclosure.

As used herein, the term module can refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module can include memory (shared, dedicated, or group) that stores code executed by the processor.

The term code, as used above, can include software, firmware, and/or microcode, and can refer to programs, routines, functions, classes, and/or objects. The term shared, as used above, means that some or all code from multiple modules can be executed using a single (shared) processor. In addition, some or all code from multiple modules can be stored by a single (shared) memory. The term group, as used above, means that some or all code from a single module can be executed using a group of processors. In addition, some or all code from a single module can be stored using a group of memories.

The apparatuses and methods described herein can be implemented by one or more computer programs executed by one or more processors. The computer programs include processor-executable instructions that are stored on a non-transitory tangible computer readable medium. The computer programs can also include stored data. Non-limiting examples of the non-transitory tangible computer readable medium are nonvolatile memory, magnetic storage, and optical storage.

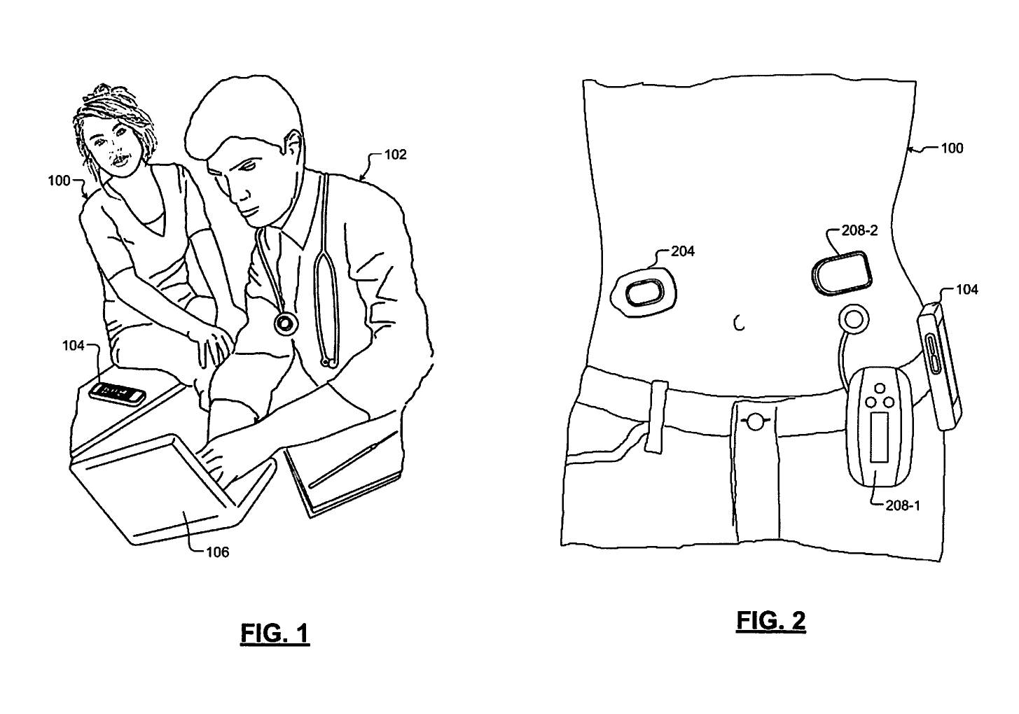

Referring now to FIG. 1, a patient 100 with diabetes and a clinician 102 are shown in a clinic environment. The term ‘patient’ encompasses persons with metabolic syndrome, pre-diabetes, type 1 diabetics, type 2 diabetics, and gestational diabetics. The term ‘clinician’ is used broadly to include nurses, nurse practitioners, physicians, endocrinologists, etc.

During a healthcare consultation, the patient 100 typically shares with the clinician 102 a variety of patient data including blood glucose measurements, continuous glucose monitor data, amounts of insulin infused, amounts of food and beverages consumed, exercise schedules, and other lifestyle information. The clinician 102 can obtain additional patient data that includes measurements of HbA1C, cholesterol levels, triglycerides, blood pressure, and weight. The patient data can be recorded manually and/or can be recorded electronically on a handheld diabetes management device 104, diabetes analysis software executed on a computing device such as a personal computer (PC) 106, and/or a web-based diabetes analysis site (not shown). The term PC, as used herein, includes computers using a Microsoft operating system as well as computers using an Apple operating system, Linux, OpenBSD, Ubuntu, etc.

The clinician 102 can analyze the patient data manually and/or can analyze the patient data electronically using the diabetes analysis software and/or the web-based diabetes analysis site. After analyzing the patient data and reviewing adherence of the patient 100 to previously prescribed therapy, the clinician 102 can decide whether to modify the therapy for the patient 100.

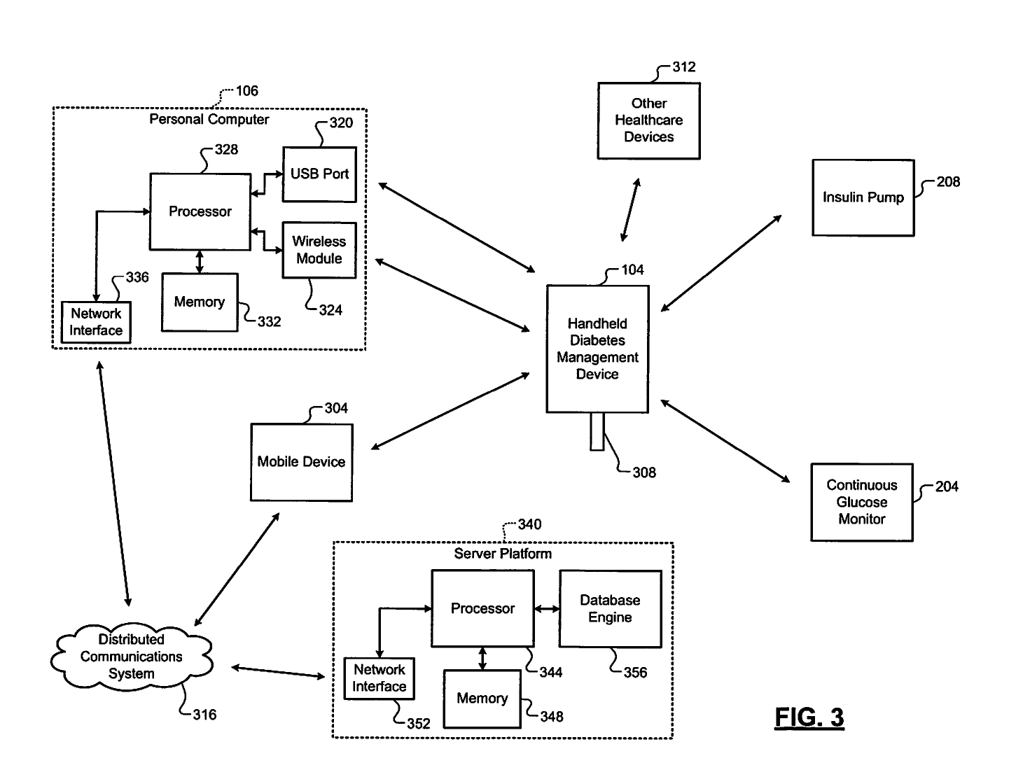

Referring now to FIG. 2, the patient 100 can use a continuous glucose monitor (CGM) 204, an ambulatory durable insulin pump 208-1, an ambulatory non-durable insulin pump 208-2, and the handheld diabetes management device 104. In various implementations, the durable insulin pump 208-1 and the non-durable insulin pump 208-2 can be used interchangeably, and the handheld diabetes management device 104 can be configured to interact with whichever of the insulin pumps 208-1 or 208-2 is currently in use. In various implementations, if both the insulin pumps 208-1 and 208-2 are worn by the patient 100, the handheld diabetes management device 104 can communicate with only one of the insulin pumps 208-1 or 208-2. In various other implementations, the handheld diabetes management device 104 can communicate with both of the insulin pumps 208-1 and 208-2. The insulin pumps 208-1 and 208-2 will be referred to collectively herein as insulin pump 208.

The CGM 204 uses a subcutaneous sensor to sense and monitor the amount of glucose in the blood of the patient 100 and communicates corresponding readings to the handheld diabetes management device 104. The handheld diabetes management device 104 performs various tasks including measuring and recording blood glucose levels, determining an amount of insulin to be administered to the patient 100 via the insulin pump 208, receiving patient data via a user interface, archiving the patient data, etc. When the CGM 204 is in use, the handheld diabetes management device 104 periodically receives readings from the CGM 204 indicating glucose level in the blood of the patient 100. When the insulin pump 208 is in use, the handheld diabetes management device 104 transmits instructions to the insulin pump 208, which delivers insulin to the patient 100. Insulin can be delivered in a scheduled manner at a basal rate, which attempts to maintain a predetermined insulin level in the blood of the patient 100. Additionally, insulin can be delivered in the form of a bolus dose, which raises the amount of insulin in the blood of the patient 100 by a predetermined amount.

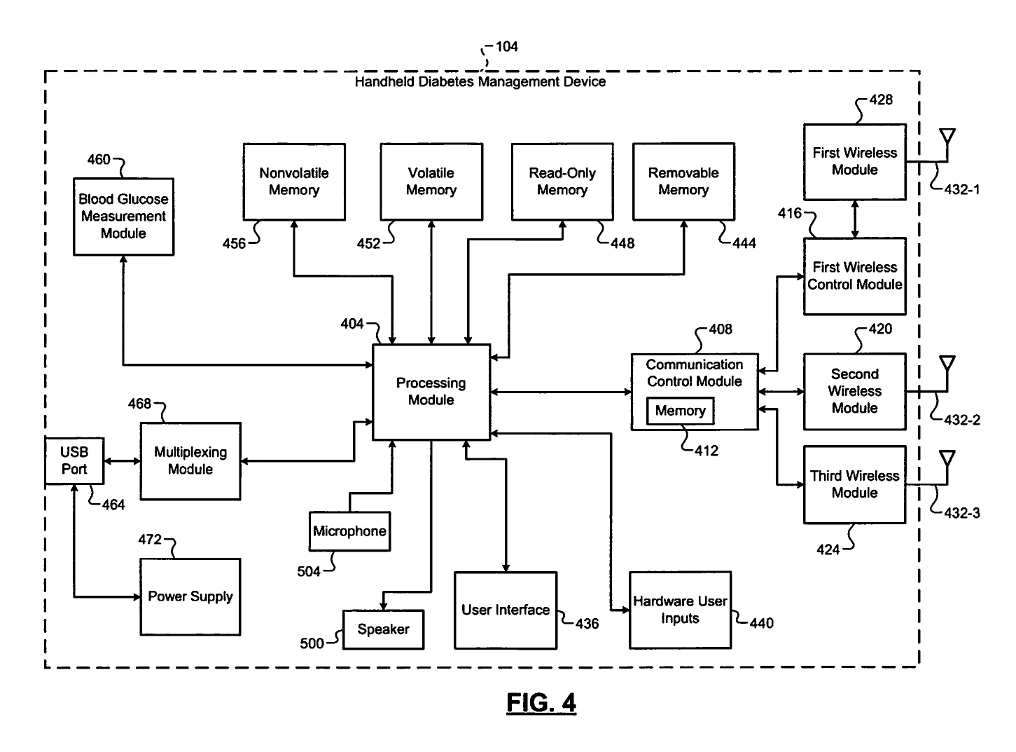

Referring now to FIG. 3, a diabetes management system used by the patient 100 and the clinician 102 includes one or more of the following devices: the handheld diabetes management device 104, the CGM 204, the insulin pump 208, the PC 106 with the diabetes analysis software, a mobile device 304, and other healthcare devices represented collectively at 312. The handheld diabetes management device 104 is configured as a system hub and communicates with the devices of the diabetes management system. Alternatively, the insulin pump 208 or the mobile device 304 can be configured as the system hub. Communication between the devices in the diabetes management system can be performed using wireless interfaces (e.g., Bluetooth) and/or wireline interfaces (e.g., USB). For example, one of versions 1.1, 1.2, 2.0, 2.1, 3.0, and 4.0 of the Bluetooth standard can be used.

Communication protocols used by these devices can include protocols compliant with the IEEE 11073 standard, which can be extended using guidelines provided by Continua® Health Alliance Design Guidelines. For example, IEEE 11703-20601 Optimized Exchange Protocol with the IEEE 11073-10417 Blood Glucose Device Specialization standards can be used. In addition, the device specialization can be supplemented by predefined Roche proprietary communications protocols, which for example can include additional measurement objects. Further, healthcare records systems such as Microsoft® HealthVault™ and Google™ Health can be used by the patient 100 and/or the clinician 102 to exchange information.

The handheld diabetes management device 104 can receive blood glucose readings from one or more sources, such as the CGM 204. The CGM 204 continuously measures the blood glucose level of the patient 100. The CGM 204 periodically communicates the blood glucose level to the handheld diabetes management device 104. In various implementations, the handheld diabetes management device 104 and the CGM 204 communicate wirelessly.

Additionally, the handheld diabetes management device 104 includes blood glucose meter (BGM) functionality. The handheld diabetes management device 104 can measure glucose levels from a sample from the patient 100. For example, in various implementations, the handheld diabetes management device 104 can receive a blood glucose measurement strip 308. The patient 100 deposits a sample of blood or other bodily fluid on the blood glucose measurement strip 308. The handheld diabetes management device 104 analyzes the sample to determine the blood glucose level in the sample. The blood glucose level measured from the sample and/or the blood glucose level read by the CGM 204 can be used in determining the amount of insulin to be administered to the patient 100.

The handheld diabetes management device 104 communicates with the insulin pump 208. The insulin pump 208 can be configured to receive instructions from the handheld diabetes management device 104 to deliver a predetermined amount of insulin to the patient 100. Additionally, the insulin pump 208 can receive additional information including meal and/or exercise schedules of the patient 100. In various implementations, the insulin pump 208 can determine the amount of insulin to administer based on the additional information.

The insulin pump 208 can also communicate data to the handheld diabetes management device 104. The data can include amounts of insulin delivered to the patient 100, corresponding times of delivery, and pump status. In various implementations, the handheld diabetes management device 104 and the insulin pump 208 can communicate wirelessly.

In addition, the handheld diabetes management device 104 can communicate with the other healthcare devices 312. For example, the other healthcare devices 312 can include a blood pressure meter, a weight scale, a pedometer, a fingertip pulse oximeter, a thermometer, etc. The other healthcare devices 312 obtain and communicate personal health information of the patient 100 to the handheld diabetes management device 104 through wireless, USB, or other interfaces. The other healthcare devices 312 can use communication protocols compliant with ISO/IEEE 11073 extended using guidelines from Continual® Health Alliance. Further, the devices of the diabetes management system can communicate with each other via the handheld diabetes management device 104.

The handheld diabetes management device 104 can communicate with the PC 106 using Bluetooth, USB, or other interfaces. Diabetes management software running on the PC 106 includes an analyzer-configurator that stores configuration information of the devices of the diabetes management system. The configurator has a database to store configuration information of the handheld diabetes management device 104 and the other devices. The configurator can communicate with users through web pages or computer screens in non-web applications. The configurator transmits user-approved configurations to the devices of the diabetes management system. The analyzer retrieves data from the handheld diabetes management device 104, stores the data in a database, and outputs analysis results through standard web pages or computer screens in non-web based applications.

The handheld diabetes management device 104 can communicate with the mobile device 304 using wired or wireless protocols, such as Bluetooth. Examples of the mobile device 304 include a cellular phone, a pager, a personal digital assistant (PDA), a tablet computing device, etc. The mobile device 304 can communicate with a network, such as a distributed communications system 316. In various implementations, the distributed communications system 316 can be the Internet. The handheld diabetes management device 104 can send and receive messages, including data and instructions, to the distributed communications system 316 via the mobile device 304.

The PC 106 includes a USB port 320 and/or a wireless module 324. A processor 328 controls communications over the USB port 320 and/or the wireless module 324. The processor 328 can execute instructions from memory 332. Further, the PC 106 includes a network interface 336, which can be wired, such as Ethernet, or wireless, such as WiFi (including 802.11a, b, g and/or n). The network interface 336 can communicate with the distributed communications system 316. The PC 106 can therefore also serve as an intermediary between the distributed communications system 316 and the handheld diabetes management device 104. The PC 106 and the handheld diabetes management device 104 can communicate using USB and using a wireless protocol, such as Bluetooth. In various implementations, the wireless protocol can be a network protocol, such as WiFi. In such implementations, functionality of the wireless module 324 and the network interface 336 can be combined into a single module.

When the handheld diabetes management device 104 is connected via USB to the PC 106, the handheld diabetes management device 104 can charge an internal power supply, such as a rechargeable battery. The PC 106 can be replaced by any other device having sufficient processing capability, such as a laptop, a netbook, or a tablet computing device. The PC 106 can execute software stored in nonvolatile storage of the PC 106. For example only, some or all of the memory 332 can be nonvolatile. Additionally or alternatively, other nonvolatile storage media can be present, such as flash memory, magnetic storage, and optical storage.

The PC 106 can execute specialized software corresponding to the handheld diabetes management device 104 and can execute general purpose software that can interact with the handheld diabetes management device 104. The PC 106 can also execute software provided by the handheld diabetes management device 104. The software provided by the handheld diabetes management device 104 can then be stored persistently on the PC 106 or can be removed when the PC 106 is no longer in communication with the handheld diabetes management device 104. In various implementations, the software provided by the handheld diabetes management device 104 can be low- or zero-footprint software such that when the handheld diabetes management device 104 is no longer in communication with the PC 106, traces of the software, such as files and settings, are not left behind on the PC 106.

The PC 106 can also acquire software via the distributed communications system 316, such as from a server platform 340. For example, the server platform 340 can provide web server functionality. The PC 106 can download and execute software from the server platform 340. In various implementations, the downloaded software can be web-based, such as a Java or Flash application. The local applications can communicate data and instructions with the server platform 340. In addition, the PC 106 can interact with a server-side application executed by the server platform 340. The remote and local applications may be known collectively as Accu-Chek 360°.

The applications can have varying functionality and access authorizations. For example, some applications can be authorized to access historical data from the handheld diabetes management device 104, while other applications can be authorized to control operation of the handheld diabetes management device 104, such as glucose measurement settings and insulin pump settings. In various implementations, the applications can also control other devices, such as the insulin pump 208 and the CGM 204, via the handheld diabetes management device 104. For example, the applications can update firmware, retrieve configuration settings and error codes, and provide configuration settings. The applications can also control firmware updates of the handheld diabetes management device 104 itself.

The server platform 340 can include one or more physical servers having multiple processors, but logically includes at least a processor 344 that executes instructions from memory 348 and communicates with the distributed communications system 316 via a network interface 352. Further, the processor 344 communicates with a database engine 356, which can be executed by a separate processor and memory and/or by the processor 344 itself, such as in a virtual machine.

The database engine 356 stores one or more databases, which can track firmware versions of the handheld diabetes management device 104 as well as associated devices, such as the CGM 204 and the insulin pump 208. The database engine 356 can store contact information for the patient 100 so that, for example, firmware updates and other alerts can be communicated to the patient 100. The database engine 356 can also store historical data from the handheld diabetes management device 104. The stored data can be used for remote access by the patient 100, the clinician 102, or in the case of a failure or erasure of the handheld diabetes management device 104.

The database engine 356 can also store language settings and localizations for various regions, and can track which of these languages are installed in the handheld diabetes management device 104. The database engine 356 can also store food and exercise databases that indicate the corresponding effect on blood sugar of various foods and activities. These databases can be supplemented by data entered by the patient 100 and/or the clinician 102 via the handheld diabetes management device 104 or via some other interface such as one presented by the PC 106. The database engine 356 can also store user preferences for the handheld diabetes management device 104 as well as treatment parameters for the handheld diabetes management device 104, such as equations and/or constants for calculating amounts of insulin.

A number of device classes are defined for use with the USB protocol. In various implementations, the handheld diabetes management device 104 implements the mass storage device class (MSC) and the personal healthcare device class (PHDC). In various implementations, the handheld diabetes management device 104 also implements the communications device class (CDC) and/or the remote network driver interface specification (RNDIS).

The MSC is used to access raw data, such as files and file systems. For example only, USB flash drives and memory card readers for digital cameras and video-cameras generally implement the MSC. The MSC is supported by a wide variety of operating systems, including Microsoft Windows, which has offered native support for MSC since Windows 2000. In various implementations, the handheld diabetes management device 104 can also implement the media transfer protocol (MTP), which also allows file access.

In various implementations, the handheld diabetes management device 104 stores blood glucose data, insulin data, exercise data, and food data as files that can be accessed via the MSC. The handheld diabetes management device 104 can also store software for use by the PC 106. In addition, the handheld diabetes management device 104 can store documentation, such as health files, frequently asked questions files, and training videos and podcasts.

The handheld diabetes management device 104 can store web pages and other interactive content. For example only, the handheld diabetes management device 104 can store a start webpage, from which a user can access other information and options. The handheld diabetes management device 104 can be configured so that the start webpage or a startup program is automatically executed when the handheld diabetes management device 104 is connected to an appropriately configured computer. The startup program can provide the option of installing the necessary components for PHDC support. To allow access via the MSC, the handheld diabetes management device 104 can implement a FAT32 file system or another file system, such as FAT, HFS Plus, and Ext2.

The PC 106 may not natively support the PHDC. For example, drivers and/or configuration files may be required prior to the PC 106 supporting communication with the handheld diabetes management device 104 using the PHDC. The handheld diabetes management device 104 can therefore store various drivers and configuration files to support the PHDC operation for one or more operating systems. The PHDC was designed to allow interoperability between medical devices, and can support IEEE 11073 operation. The PC 106 can communicate with the handheld diabetes management device 104 using the PHDC in order to obtain medical data, such as blood glucose readings and historical insulin injection records. The PC 106 can also use the PHDC to read and command basal rate and bolus parameters.

The handheld diabetes management device 104 can implement the CDC to allow direct communication between the PC 106 and various components of the handheld diabetes management device 104. The CDC allows a variety of pre-existing communication protocols, such as serial protocols and network protocols, to be carried over USB. For example only, the PC 106 can communicate with an internal component of the handheld diabetes management device 104 using the CDC. Additionally, the PC 106 can use the CDC to communicate with other devices, such as the CGM 204 and the insulin pump 208, via the handheld diabetes management device 104. In addition, the CDC can be used during manufacturing, testing, calibration, and repair. For example, the CDC can be used by a specialized test environment, such as a test stand, and/or by a computer having specialized software. In various implementations, end users are prevented from using the CDC. Additionally or alternatively to implementing the CDC, the Remote Network Driver Interface Specification (RNDIS) can be used. RNDIS is a specification for supporting network devices over USB, and is supported natively in some Microsoft operating systems.

As discussed above, the handheld diabetes management device 104 can communicate with the PC using a wireless protocol such as Bluetooth. Although Bluetooth is described herein for purposes of illustration only, other protocols can be used, such as ZigBee or Bluetooth low energy. Similar to the classes of USB, profiles are defined for Bluetooth. For example, the handheld diabetes management device 104 can implement a serial port profile (SPP) and/or a health device profile (HDP). The SPP defines protocols and procedures to allow devices to emulate a serial protocol, such as RS-232, using Bluetooth.

In various implementations, the SPP can be used in similar scenarios as the CDC of USB. For example, the SPP can be used by the PC 106 to communicate with the CGM 204 and/or the insulin pump 208 via the handheld diabetes management device 104. Further, the handheld diabetes management device 104 can use the SPP to communicate with the CGM 204 and the insulin pump 208. For example only, the SPP can be used for configuration and updating of the CGM 204 and the insulin pump 208. The handheld diabetes management device 104 can use the HDP for supplying and receiving medical data to and from the CGM 204 and the insulin pump 208, such as blood glucose readings and insulin doses.

The HDP can be used in conjunction with IEEE 11073. The HDP can be used when transmitting medical information from the handheld diabetes management device 104 to the PC 106. The medical information can include glucose readings, exercise data, and food data from handheld diabetes management device 104 as well as glucose readings from the CGM 204 and insulin dosing history from the insulin pump 208.

Referring now to FIG. 4, a functional block diagram of an example implementation of the handheld diabetes management device 104 is presented. The handheld diabetes management device 104 includes a processing module 404, such as the i.MX233 applications processor from Freescale Semiconductor, Inc. For example only, the processing module 404 runs the Windows CE operating system from Microsoft Corp. The processing module 404 communicates with a communication control module 408, such as an STM32F103 32-bit ARM Cortex microcontroller unit from ST Microelectronics. For example only, the communication control module 408 includes memory 412 having volatile and nonvolatile components. For example only, the communication control module 408 includes 512 KB of flash memory and 64 KB of random access memory (RAM).

The processing module 404 and the communication control module 408 can communicate using universal asynchronous receiver/transmitters (UARTs). In various implementations, a level shifter or a voltage transformer is interposed between the processing module 404 and the communication control module 408 to match signal levels of the respective UARTs. The communication control module 408 controls wireless communication. In various implementations, the communication control module 408 controls a first wireless control module 416 and a second wireless module 420. In various implementations, the communication control module 408 also controls a third wireless module 424.

The first wireless control module 416 controls a first wireless module 428, which can implement RF processing and/or baseband processing. Antennas 432-1, 432-2, and 432-3 are illustrated as being connected to the first wireless module 428, the second wireless module 420, and the third wireless module 424, respectively. However, more or fewer antennas can be used. When fewer antennas are used, access to the antenna can be multiplexed and/or different frequency operating ranges can allow antenna to be used by different modules simultaneously. Further, RF and/or baseband processing can be shared between modules. In various implementations, the first wireless control module 416 can subsume the functionality of the first wireless module 428.

The first wireless control module 416 can implement encryption, such as the advanced encryption standard (AES), to prevent eavesdropping and other malicious activity from affecting the wireless communication. The first wireless control module 416 can implement a proprietary wireless protocol operating in a specified frequency band, such as the 2.4 GHz industrial, scientific, and medical (ISM) band. For example, the first wireless control module 416 can be an nRF24LE1™ ultra-low-power wireless system-on-chip solution from Nordic Semiconductor, Inc.

The second wireless module 420 can implement a wireless personal area network (WPAN) protocol such as Bluetooth, Bluetooth low energy, or Zigbee. For example only, the second wireless module 420 can be a BL6450 controller from Texas Instruments. When present, the third wireless module 424 can implement another proprietary wireless protocol and/or a wireless local area network (WLAN) protocol, such as IEEE 802.11(a, b, g, and/or n).

The processing module 404 communicates with a user interface 436, which can include a liquid crystal display (LCD) touchscreen, which can be backlit by light-emitting diodes (LEDs). For example only, the touchscreen can be a WQVGA (400×240) 3-inch screen. The processing module 404 can receive hardware user inputs 440. For example only, the hardware user inputs can include buttons and switches, such as a microswitch for performing a hardware reset. The microswitch can be recessed to prevent accidental actuation.

The processing module 404 can communicate with removable memory 444, such as flash storage, including secure digital (SD), compact flash (CF), and other flash storage technologies. For example, the removable memory 444 can be a microSD card. The removable memory 444 can be used to store the software, instructional material, and drivers to be provided to the PC 106 and/or the mobile device 304.

The processing module 404 also communicates with read-only memory 448. The read-only memory 448 can include an electrically erasable programmable read-only memory (EEPROM). The processing module 404 communicates with volatile memory 452, such as synchronous dynamic random access memory (SDRAM). The processing module 404 communicates with nonvolatile memory 456, such as NAND flash memory. In various implementations, some or all of the read-only memory 448, the volatile memory 452, and the nonvolatile memory 456 can be incorporated on the same die or in the same package as the processing module 404.

The processing module 404 communicates with a blood glucose measurement module 460, which analyzes a sample from the patient 100 to determine a glucose level in the patient's blood. For example only, the blood glucose measurement module 460 can dispense test strips to which a blood sample is applied. In various implementations, the blood glucose measurement module 460 processes readings from the sample and provide a blood glucose number to the processing module 404. Alternatively, the blood glucose measurement module 460 can provide raw data to the processing module 404, which determines a blood glucose level based on the raw data.

The handheld diabetes management device 104 includes a USB port 464. For example, the USB port 464 can be a standard USB port, a micro USB port, or a mini USB port. Specifically, the USB port 464 can be a micro-B female port. The small size of the micro-B port offers less area for potential fluid or other contaminant intrusion, and allows a physical size of the handheld diabetes management device 104 to be minimized.

To reduce the number of physical ports required in the handheld diabetes management device 104, a multiplexing module 468, such as an MC34825 from Freescale Semiconductor, Inc., is connected to the USB port 464. The multiplexing module 468 can allow the USB port 464 to be used for USB purposes, for a non-USB serial interface, and for an audio interface. In addition, a power supply 472 can be connected to the USB port 464. The power supply 472 can include a battery, such as a lithium ion rechargeable battery, which provides power to components of the handheld diabetes management device 104.

The power supply 472 can be recharged via the USB port 464. In various implementations, the power supply 472 can be recharged when the USB port 464 is connected to the PC 106 and/or a powered USB hub. In addition, a separate adapter can be used to recharge the power supply 472 via the USB port 464. In various implementations, the current required by the power supply 472 is greater than can be provided by a computer, and charging therefore requires the charging adapter. The charging adapter can be integrated with a stand that retains the handheld diabetes management device 104 and also allows interaction with the user interface 436 of the handheld diabetes management device 104. Charging using the USB port 464 allows a separate charging port to be eliminated.

In various implementations, the multiplexing module 468 can analyze cables and/or devices connected to the USB port 464. For example only, termination resistances, pull-up resistances, and pull-down resistances of cables and/or devices attached to the USB port 464 can indicate to the multiplexing module 468 the type of device connected to the USB port 464. When the multiplexing module 468 determines that a USB device is attached, the multiplexing module 468 can connect the USB port 464 to a USB interface of the processing module 404.

Similarly, the multiplexing module 468 can connect the USB port 464 to a serial interface when a non-USB serial device is determined to be connected to the USB port 464. The multiplexing module 468 connects the USB port 464 to an audio interface when an audio device is determined to be connected to the USB port 464.

The processing module 404 determines whether the USB interface should be operating using the PHDC, the MSC, the CDC, or another class. After manufacturing, the processing module 404 can initially control the USB interface to operate using the CDC. This mode can be used for programming, configuration, calibration, and testing. The processing module 404 can then control the USB interface to operate using the MSC prior to providing the handheld diabetes management device 104 to the patient 100. Repair and testing facilities can provide signals and/or commands to the processing module 404 to indicate that CDC is once again required, such as if the handheld diabetes management device 104 is returned for servicing.

When the handheld diabetes management device 104 is with the patient 100, the processing module 404 can set the USB interface to use the MSC by default. However, if it is determined that the device connected to the USB port 464 has the necessary drivers and configuration to use the PHDC, the processing module 404 can set the USB interface to use the PHDC. A user of the handheld diabetes management device 104 and user of the connected device can override this operation and cause the processing module 404 to maintain the USB interface using the MSC. The MSC can allow the USB interface to provide access to the removable memory 444. When operating using the CDC, the USB interface can communicate with, for example, the blood glucose measurement module 460 and/or with the communication control module 408.

The serial interface implements a non-USB protocol, such as the inter-integrated circuit (I²C) protocol, General Purpose Input/Output (GPIO), and/or RS-232. The non-USB serial protocol can be used during manufacturing and testing by test equipment that has a serial interface. By multiplexing the non-USB pins onto the USB port 464, the need for a separate serial port, such as a 9-pin DE-9, can be eliminated.

The processing module 404 can include an audio amplifier for powering a speaker 500 and an audio amplifier for amplifying signals from a microphone 504. The processing module 404 can convert analog microphone signals into digital and converts digital sound signals into analog signals for playback. For example only, the microphone 504 can be used to record journal entries corresponding to insulin doses, exercise, meals, and blood glucose readings. The speaker 500 can be used to play back journal entries and/or to play audio and video files, such as instructional videos. The audio and video files can be stored in the removable memory 444.

The audio interface is selectively connected to the USB port 464 by the multiplexing module 468. The pins of the USB port 464 are thereby used as microphone and/or headphone conductors. By using the USB port 464, the need for separate audio connectors, such as tip/ring/sleeve (TRS) connectors, can be eliminated. An adapter can be used that simply electrically connects one or two TRS connectors to the conductors on a USB plug. When the adapter is used, standard headphones and microphones can be used. When an audio device, such as a set of headphones, with or without a microphone, is connected to the USB port 464, the processing module 404 can disable amplification of the microphone 504 and the speaker 500.

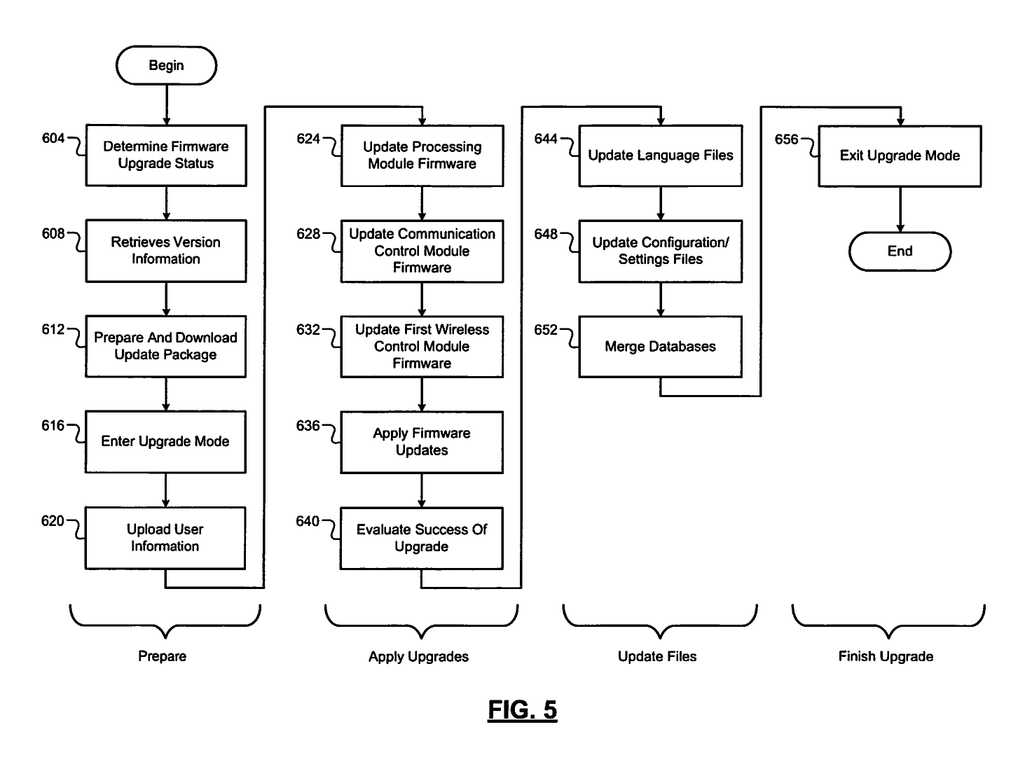

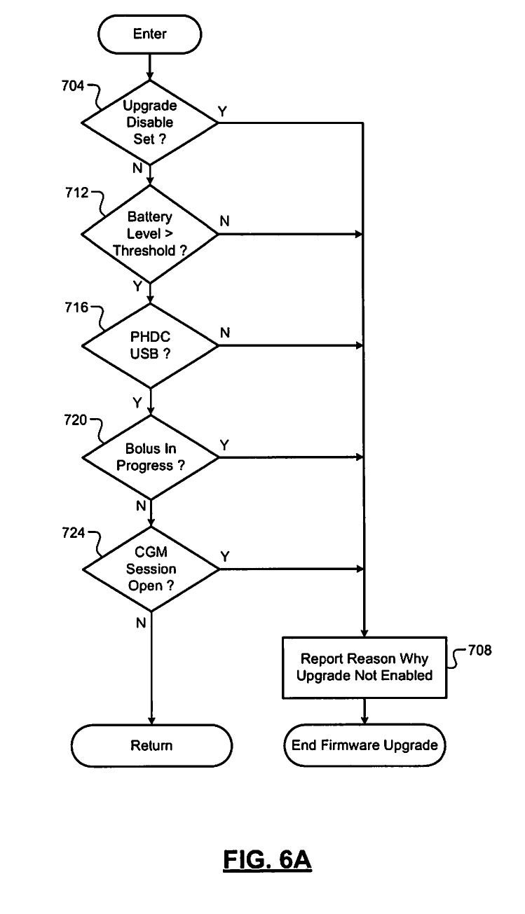

Referring now to FIG. 5, a flowchart depicts an overview of exemplary firmware upgrading operation. Control begins at 604 when a firmware upgrade is requested. The firmware upgrade can be requested by the patient 100, the clinician 102, another user, and/or a periodic upgrade checking process. In addition, in various implementations, a firmware upgrade can be requested by software running on the PC 106, the mobile device 204, or the server platform 316.

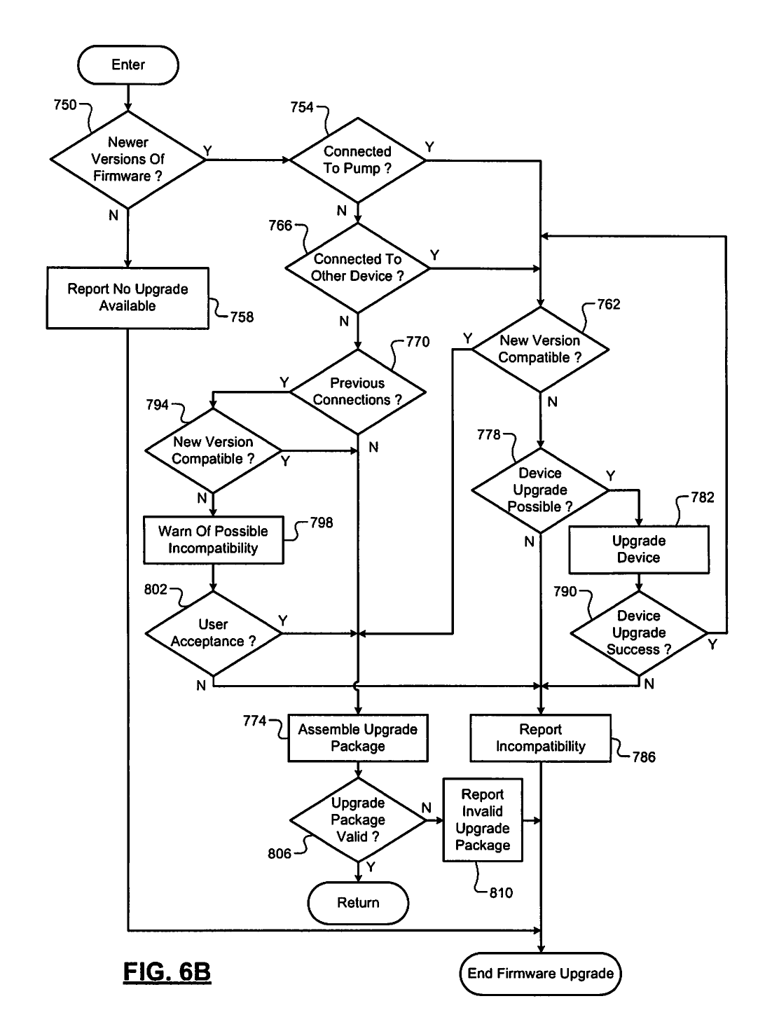

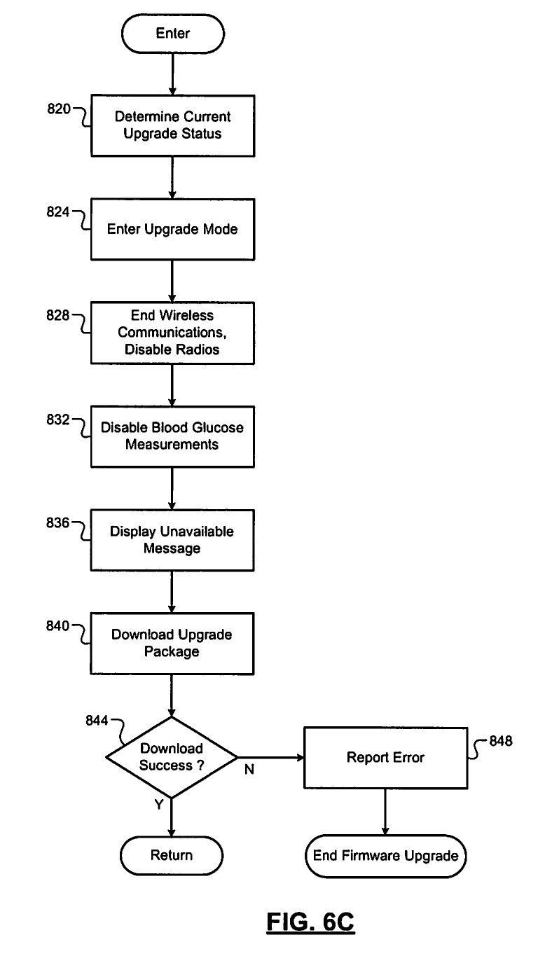

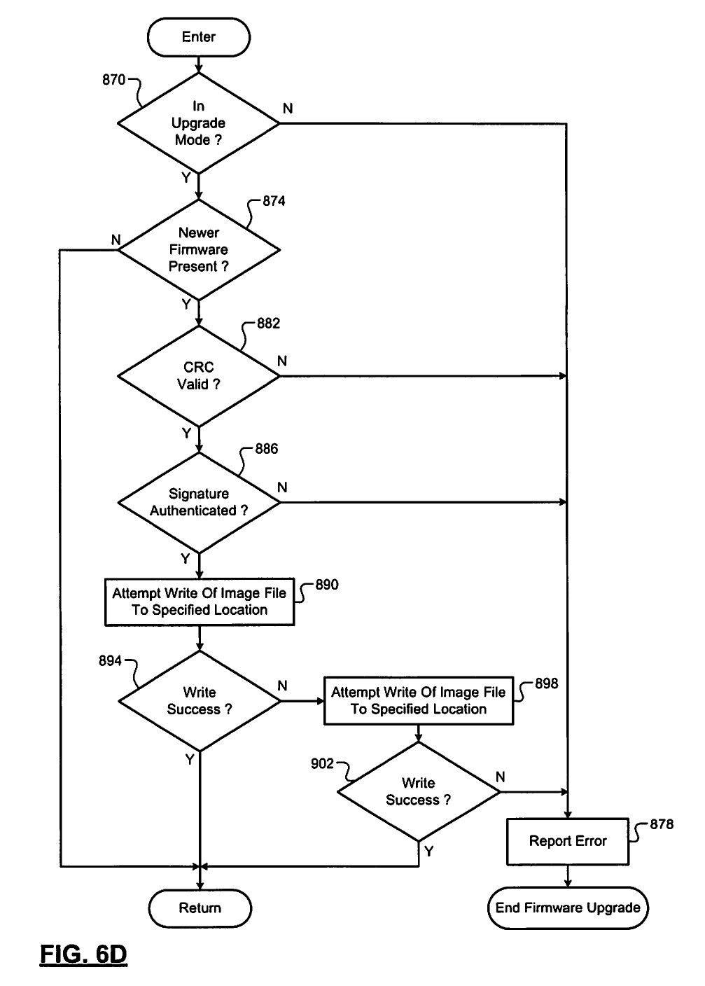

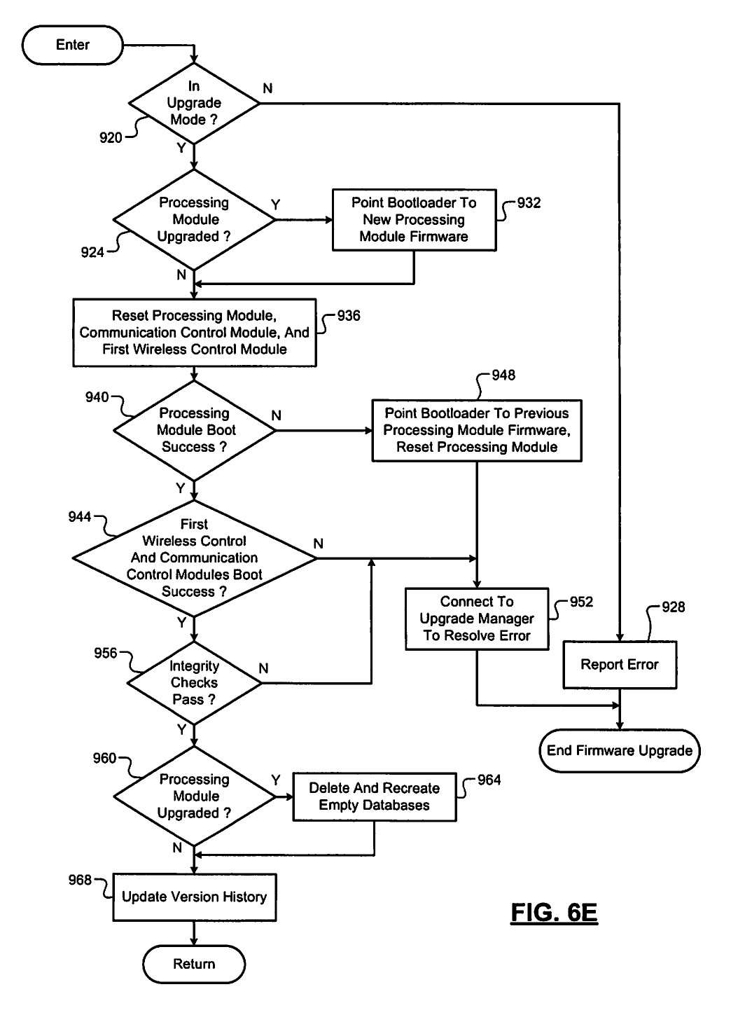

For example, a person, such as the patient 100 or the clinician 102, can request an upgrade in response to receiving a notification that the upgrade is available. The notification can be sent in the form of an email, a letter, a phone call, a text message, a notice on a website, and/or a notice generated by software running on the PC 106. Control operations in FIGS. 5 and 6A-6E can be shared between the handheld diabetes management device 104 and remote software, which can be executing on the PC 106, the mobile device 304, and/or the server platform 316, or a combination thereof. Some operational tasks are performed only by one of these entities, while other tasks are shared between the entities. For purposes of illustration only, some operational tasks will be described as being assigned to only one of the entities. However, depending on implementation details, business rules, and regulatory requirements, tasks can be reassigned and/or reapportioned among the entities.

At 604, control determines the current upgrade status. If the preconditions for performing an upgrade are met, a firmware upgrade is currently possible and control continues at 608; otherwise, control indicates the reasons for why the upgrade is currently not allowed and ends the upgrade. Control can also provide an indication, such as to the patient 100, clinician 102, or remote software regarding what steps can be taken to reach a status where the firmware upgrade is allowed. An example implementation of 604 is shown in FIG. 6A.

At 608, control retrieves version information. The version information can include versions of software residing on components of the handheld diabetes management device 104, versions of hardware components of the handheld diabetes management device 104, and hardware and software versions of associated devices, such as the CGM 204 and the insulin pump 208. Version information can also include versions of communication interfaces, database files, language files, and configuration files. Version information can also include serial numbers and model numbers of the handheld diabetes management device 104 and any recently associated devices. The version information can be used locally by the handheld diabetes management device 104 or transmitted to the remote software.

Control continues at 612, where control prepares and selectively downloads an update package. Control determines whether newer versions exist of any of the items indicated by the version information of 608. In various implementations, some of the version information indicates versions of components, such as hardware components, read-only memories, and low-level software such as boot loaders, that cannot be upgraded. The version information of these components can be used to determine compatibility of available software upgrades.

In addition, upgrade dependencies can be present. For example, software on the CGM 204 and/or the insulin pump 208 may need to be updated prior to updating the handheld diabetes management device 104. Control can require that any currently or recently associated (or, ‘paired’ in the context of Bluetooth) devices be upgraded to maintain compatibility with upgraded software in the handheld diabetes management device 104. If the handheld diabetes management device 104 has historically been paired or associated with devices for which upgrades would be necessary, but which have not bee used recently, control can report this potential incompatibility.

In cases where the patient 100 is no longer making use of such device, control can proceed with the upgrade as the potential incompatibility of that device is irrelevant. Upgrades to attached devices can be performed at this time, prior to performing any further upgrade tasks on the handheld diabetes management device 104. In various implementations, devices such as the CGM 204 and the insulin pump 208 can be upgraded via the handheld diabetes management device 104. For example, USB passthrough can be used to communicate between the PC 106 and the CGM 204 and/or the insulin pump 208. In various implementations, control can upgrade the CGM 204 and the insulin pump 208 even when no upgrades are present and/or applied to the handheld diabetes management device 104.

If any upgrades are present for the handheld diabetes management device 104, control acquires each portion of the upgrade and assembles them into an upgrade package. For example only, the individual portions can be verified using an integrity check, such as a cyclic redundancy check (CRC) and/or a hash, such as a cryptographic hash. The upgrade components can also be verified using a cryptographic signature, such as a hash of the component encrypted by a private key, the corresponding public key being known by control.

In various implementations, license agreements and/or warnings and/or instructions are presented prior to assembling the update package. In implementations where the handheld diabetes management device 104 has not assembled the update package, control then initiates a transfer of the update package to the handheld diabetes management device 104. An example implementation of 612 is shown in FIG. 6B.

Control continues at 616 and enters upgrade mode. In upgrade mode, the handheld diabetes management device 104 automatically attempts to reestablish communication with the remote software if communication is lost, such as upon a reboot. In various implementations, upgrade mode suspends all non-upgrade functionality of the handheld diabetes management device 104, including suspending blood glucose measurements, test strip dispensing, and user interface interaction. Control can also close all databases, which can include configuration and settings databases.

Control also ends wireless communications and disables all radios. In implementations where communication with the remote software is being performed over a wireless connection, the corresponding wireless radio remains enabled. The handheld diabetes management device 104 remains in upgrade mode until instructed to leave upgrade mode by the remote software. In various implementations, while in upgrade mode, if a software or hardware reset occurs, the handheld diabetes management device 104 can skip all normal checks and internal tests and attempt to reestablish communication with the remote software as quickly as possible and without user interaction. An example implementation of 616 is shown in FIG. 6C.

Control continues at 620, where user information is uploaded to the remote software. The user information can include confirmation and setting information, food, exercise, blood glucose, and insulin data. In various implementations, some or all of this data can be backed up to the server platform 316. In various implementations, some or all of the user information is already backed up to mitigate the effects of loss or damage to the handheld diabetes management device 104. The backup can be user-initiated or occur during clinic visits or on a periodic schedule. Operation at 604, 608, 612, 616, and 620 can be considered to be part of a preparation phase.

Control then continues at 624. At 624, control updates, if necessary, firmware of the processing module 404. Control can verify once again that the handheld diabetes management device 104 is in upgrade mode. Then control also verifies the integrity and authenticity of the upgrade package on the handheld diabetes management device 104.

Control then attempts to write the firmware to a predetermined memory location. For example only, control attempts to write the firmware for the processing module 404 to a predetermined memory location in the nonvolatile memory 456. To allow the processing module 404 to revert back to the previous software should the new software fail for any reason, the previous software is not overwritten in the nonvolatile memory 456. If the write fails, control can attempt additional writes. In various implementations, the number of attempts is limited to two. Control reports the success or failure to the remote software, and can also indicate whether more than one attempt was necessary. An example implementation of 624 is shown in FIG. 6D.

To improve reliability, the entire firmware of the processing module 404 can be updated at once. This removes the possibility of new upgrades conflicting with old components. Essentially, each upgrade of the processing module is a new self-contained firmware image. Similarly, the firmware for the communication control module 408 and for the first wireless control module 416 can be upgraded as a single image.

Control continues at 628, where if applicable, control updates firmware of the communication module 408. Operation of 628 may be similar to that of 624. For example, the processing module 404 can verify the integrity and authenticity of the upgrade. The processing module 404 then transmits the upgrade to the memory 412 of the communication control module 408.

Control continues at 632, where control updates, if applicable, the first wireless control module 416. The processing module 404 can verify the integrity and authenticity of the upgrade before sending the upgrade to the first wireless control module 416 via the communication control module 408. The communication control module 408 can operate as a serial passthrough device during this process. In various implementations, the second wireless module 420 and the third wireless module 424 are not upgraded. However, configuration parameters and/or startup scripts can be stored by the communication control module 408 and read by the second wireless control module 420 and/or the third wireless module 424 upon startup. These configuration parameters can be considered as part of the upgrade of the communication control module 408.

In various implementations, the upgrade of the communication control module 408 overwrites the previous software stored by the communication control module 408. If operation of the communication control module 408 fails when using the new software, the processing module 404 can write the old software back to the communication control module 408. In various implementations, the processing module 404 can retrieve the old version of the software from the remote software. Alternatively, the processing module 404 can maintain the previous version in memory, such as the nonvolatile memory 456.

The software for the communication control module 408 can be read from the communication control module 408 and written into the nonvolatile memory 456 prior to writing the new software. Alternatively, the nonvolatile memory 456 can persistently store the most recent software installed in the communication control module 408. Then if the new software fails, the most recent functioning software from the nonvolatile memory 456 can be reinstalled. In various implementations, the nonvolatile memory 456 can be populated at the time of manufacture with the version of software initially installed in the communication control module 408. In this way, prior to the very first upgrade of the communication control module 408, the nonvolatile memory 456 will already have the most recent functioning version of the software stored. A similar backup can be maintained for the software in the first wireless control module 416. After new software has been installed on the communication control module 408, and all integrity checks have been passed upon reboot, the nonvolatile memory 456 can be similarly updated with the new functioning software that was installed in the communication control module 408.

Control continues at 636, where control applies the firmware upgrades. At 636, control applies the firmware upgrades. When new software has been installed in the nonvolatile memory 456 with the processing module 404, the boot loader of the processing module 404 is updated to point to the new software. For example only, a starting address of the new software is stored in the boot loader. Then a reset instruction is issued, which resets the processing module 404 and can also reset the communication control module 408 and the first wireless control module 416.

The boot loader causes the processing module 404 to execute the new software from the nonvolatile memory 456. If booting the new software is not successful, the processing module 404 is rebooted, and the boot loader reverts execution back to the previous software. For example only, the boot loader can store a flag indicating that a boot using the new software has been attempted. When booting using the new software succeeds, the new software can clear the flag in the boot loader. Therefore, if the boot loader sees that the flag is still set during a boot, the boot loader can recognize that booting using the new software failed and revert to the old software.

A software and/or hardware watchdog timer can be implemented to ensure that the processing module 404 does not freeze. After a predetermined period of time, the watchdog timer can issue a reset command to the processing module 404, which can then boot using the old software. Further, one of the hardware user inputs 440, such as a recessed microswitch, can be used by a user to reset the handheld diabetes management device 104 when the user recognizes that the handheld diabetes management device 104 is unresponsive.

If booting of either the communication control module 408 or the first wireless control module 416 fails, the processing module 404 can reinstall the previous software into the failing control module. If all boots prove successful, however, control can execute self-tests to ensure proper functioning. If any of the boots fail or if an integrity check fails, control reports this failure to the remote software. The remove software can attempt to troubleshoot the problem, which includes reinstalling software, installing an intermediary version of software, or reverting everything to the previous version. In various implementations, the remote software has the ability to disable all functionality of the handheld diabetes management device 104 until new software can be properly installed. This capability can be used when installation of updates is required, which can be determined by the manufacturer and/or a regulatory agency.

If all integrity checks are successful, control can update a version history stored in the handheld diabetes management device 104. The version history can include everything described with respect to the version information of 608. In addition, the version history can include records of all previous versions installed and can include the dates and times at which the versions were installed. When the processing module 404 has been updated, databases used by the processing module 404 can be deleted and recreated to ensure compatibility with the new version of the firmware of the processing module 404. An example implementation of 636 is shown in FIG. 6E.

Control continues at 640, where the success of the upgrade is evaluated. This can include providing the version information to the remote software to allow the remote software to verify that the most up-to-date versions are now installed. The remote software can also store this data, which may be required in some jurisdictions for regulatory compliance. In various implementations, firmware versions are tracked by serial number and no information correlating serial number with patient information is maintained. This insures privacy while still allowing for reliable tracking of firmware versions across devices. For example, manufacturers can determine what compatibility issues could be present when various software components are upgraded and can be used to identify devices that are in need of critical updates and/or that have not been updated recently. Control operation at 624, 628, 632, 636, and 640 can be considered an apply upgrade phase.

Control continues at 644, where language files are updated. For example only, the default language of the software install is English. Additional languages can be added after a successful installation. In any given jurisdiction, regulatory agencies may require that certain languages are installed. The remote software can therefore provide these mandatory languages to the handheld diabetes management device 104. In addition, the user may previously have installed one or more additional languages. These language files can also be provided to the handheld diabetes management device 104. As with software updates, the processing module 404 can verify the integrity and authenticity of received language files before installing and using language files. Versions of the installed language files can then be stored in the version history.

Control continues at 648, where configuration and settings files are transferred to the handheld diabetes management device 104. In various implementations, a user's previous configurations and settings can be merged into a new database version, which is then provided to the handheld diabetes management device 104. Control continues at 652, where control merges additional databases and installs those databases on the handheld diabetes management device 104. For example only, a patient 100 or clinician 102 can add foods to the food database, which can include descriptions, comments, carbohydrate content, and other nutrition information. The patient 100 or clinician 102 can manually enter this information or acquire it from some other source, such as a third party or the manufacturer. This additional food database information, backed up 620, can be added to an updated food database from the manufacturer. This merged food database is then provided to the handheld diabetes management device 104. Similarly, custom exercise information can be present in an exercise database, which can indicate the effects on blood sugar of various exercise activities.

In cases where the remote software merges user-provided information into a database, the mode of authentication provided by the manufacturer no longer covers the updated database. For example, the remote software can itself authenticate the updated database using a private key known only to the remote software. The processing module 404 can verify the authenticity of the updated database using a corresponding public key. Control operation at 644, 648, and 652 can be considered as part of an update file phase.

Control continues at 656, where control exits the upgrade mode. In various implementations, exiting the upgrade mode is only initiated by the remote software, so that a successful upgrade of the handheld diabetes management device 104 is verified by and known by the remote software. Upon receiving the exit upgrade mode instruction, the handheld diabetes management device 104 acknowledges the instruction to the remote software, exits upgrade mode, and reboots.

In other words, a reset instruction can be issued to the processing module 404, the communication control module 408, and the first wireless control module 416. In addition, reset signals can also be applied to the second wireless module 420 and the third wireless module 424, as well as other components of the handheld diabetes management device 104. During a standard boot process, the processing module 404 verifies versions and integrity of installed software. Following the first normal boot after an upgrade, the handheld diabetes management device 104 reconnects to the remote software and indicates whether the standard version and integrity checks, as well as any other self-tests, were successful. The upgrade process then ends.

Referring now to FIG. 6A, control enters at 704. If an upgrade disable setting is set, such as in the handheld diabetes management device 104 or the remote software, control transfers to 708; otherwise, control transfers to 712. At 712, if a battery level of the handheld diabetes management device 104 is greater than a threshold, control continues at 716; otherwise, control transfers to 708. At 716, control verifies that a USB post is connected using the PHDC. If so, control transfers to 720; otherwise, control transfers to 708. In various implementations, upgrading can be allowed over other interfaces. In such implementations, 716 can be updated to allow those interfaces as well.

At 720, control determines whether a bolus is in progress. If so, control transfers to 708; otherwise, control transfers to 724. Alternatively, at 720, control can wait until the bolus has completed and then transfer to 724. At 724, control determines whether a CGM session is open. If so, control transfers to 708; otherwise, the handheld diabetes management device 104 is ready for upgrading and control returns. At 708, control reports the reason why the upgrade is not currently enabled and the firmware upgrade process is ended. The reason can be reported to the remote software and/or to the handheld diabetes management device 104. The reason, as well as information on how to address the reason, can be displayed to a user, such as the patient 100 or the clinician 102.

Referring now to FIG. 6B, control enters at 750. Control determines whether there are newer versions of firmware based on the version information retrieved at 608 of FIG. 5. If so, control transfers to 754; otherwise, control transfers to 758. At 758, control reports that no upgrade is available and ends the firmware upgrade process. At 754, control determines whether a connection is open with an insulin pump. If so, control transfers to 762; otherwise, control transfers to 766.

At 766, control determines whether a connection (or, a pairing in the context of Bluetooth) is open with another device. If so, control transfers to 762; otherwise, control transfers to 770. At 762, control determines whether new versions of the firmware for the handheld diabetes management device 104 are compatible with the pump or the other device. If so, control transfers to 774; otherwise, control transfers to 778. At 778, control determines whether an upgrade of the potentially incompatible device is possible. If so, control transfers to 782; otherwise, control transfers to 786.

At 782, control attempts to upgrade the device. At 790, if the upgrade is successful, control returns to 762 to recheck compatibility. Otherwise, control transfers to 786. At 786, control reports incompatibility between new versions of the firmware and connected devices and ends the firmware upgrade. At 770, control determines whether previous connections have been made to devices, such as a pump or other device such as a CGM. If so, control transfers to 794; otherwise, control transfers to 774. In 794, control determines whether the new versions of firmware are compatible with previously connected devices. If so, control transfers to 774; otherwise, control transfers to 798.

At 798, control warns of possible incompatibility with previously connected devices. If a user, such as the patient 100 or the clinician 102, accepts this possible incompatibility at 802, control transfers to 774; otherwise, control transfers to 786. At 774, control assembles an upgrade package including the newer versions of the firmware(s). At 806, control determines whether the upgrade package is valid, such as by checking integrity and authenticity. If valid, control returns; otherwise, control transfers to 810. At 810, control reports that the upgrade package is invalid and ends the firmware upgrade.

Referring now to FIG. 6C, control enters at 820, where control re-verifies that the handheld diabetes management device 104 is currently able to upgrade its firmware. Control continues at 824, where upgrade mode is entered. As described above, upgrade mode treats connectivity with the remote software as the highest priority in order to allow the remote software to monitor progress of the upgrade and troubleshoot any problems. Control continues at 828, where control ends wireless communications and disables radios. If communication with the remote software is performed via one of the radios, that radio is left enabled. However, no other connections besides the connection required for the connection with the remote software is allowed.

Control continues at 832, where control disables blood glucose measurements, which can also include disabling dispensing of test strips. Control continues at 836, where control displays a message indicating unavailability on user interface 436 of the handheld diabetes management device 104. Control continues at 840, where control attempts to download the upgrade package from the remote software. If the handheld diabetes management device 104 itself had prepared the upgrade package, the components of the upgrade package will already have been verified on the handheld diabetes management device 104. Control continues at 844, where if the download is successful, control returns; otherwise control transfers to 848. At 848, control reports an error and waits for instructions from the remote software. In various implementations, control then ends the firmware upgrade and exits from upgrade mode. If the reason that the download failed can be resolved, another upgrade process can then be initiated.

Referring now to FIG. 6D, control enters at 870. Control verifies that the handheld diabetes management device 104 is still operating in upgrade mode and continues at 874; otherwise, control transfers to 878. At 874, control determines whether newer firmware is present. If so, control transfers to 882; otherwise, control returns. Because FIG. 6D can describe high level operation of 624, 628, and 632 of FIG. 5, one or more of the modules may not have newer firmware. At 882, control uses a cyclic redundancy check or other mechanism for verifying integrity of the firmware. If the firmware appears uncorrupted, control transfers to 886; otherwise, control transfers to 878.

At 886, control determines whether the firmware is authentic, such as by verifying a signature. If the firmware is authentic, control transfers to 890; otherwise, control transfers to 878. At 890, control attempts to write the firmware image file to a specified location. For example only, the specified location for the processing module 404 is the nonvolatile memory 456, the specified location for the communication control module 408 is the memory 412, and the specified location for the first wireless control module 416 is internal memory of the first wireless control module 416. Control continues at 894, where if the write is successful, control returns; otherwise, control transfers to 898. At 898, control reattempts a write of the image file to the specified location. If at 902, the write is successful, control returns; otherwise, control transfers to 878.

At 878, control reports an error to the remote software. The remote software determines an appropriate response. For example, when writing new firmware for the processing module 404, if the write fails, the previous software will continue to be used. However, in various implementations, writing new software to the communication control module 408 or to the first wireless control module 416 overwrites the previous software. The remote software can therefore instruct the processing module 404 to overwrite the communication module 408 and/or the first wireless control module 416 with the previous version of the software.

Referring now to FIG. 6E, control enters at 920. At 920, if the upgrade mode is still enabled, control continues at 924; otherwise, control transfers to 928. At 928, control can attempt to re-enter upgrade mode, and/or can attempt to establish communication with the remote software. Control reports the error to the remote software, and can replace the firmware in the communication control module 408 and the first wireless control module 416. The firmware upgrade process then ends.

At 924, control determines whether the processing module 404 has been upgraded. If so, control transfers to 932; otherwise, control transfers to 936. At 936, control resets the processing module 404, the communication module 408, and the first wireless control module 416. Control continues at 940 where control determines whether the processing module 404 successfully booted. If so, control transfers to 944; otherwise, control transfers to 948.

At 948, control points the boot loader to the previous firmware for the processing module 404 and resets the processing module 404. Control then continues at 952. At 944, control determines whether the first wireless control module 416 and the communication control module 408 successfully booted. If so, control transfers to 956; otherwise, control transfers to 952. At 956, control runs integrity checks. If the integrity checks all pass, control transfers to 960; otherwise, control transfers to 952. At 952, control connects to the upgrade manager to resolve the error. At 960, control determines whether the processing module 404 has been upgraded. If so, control transfers to 964; otherwise, control transfers to 968. At 964, control deletes current databases and recreates empty databases based on definitions in the new firmware. Control continues at 968, where control updates the version history to reflect the upgraded versions of the firmware and databases. Control then returns.

The present disclosure describes a handheld diabetes management device that implements a failsafe firmware upgrading protocol to reduce risk of device downtime and to reduce required user interaction. The handheld diabetes management device includes a nonvolatile memory and a general processing module in electrical communication with the nonvolatile memory. The general processing module executes first software from the nonvolatile memory. An external port is in electrical communication with the general processing module. The general processing module receives second software from the external port and writes the second software to the nonvolatile memory.

Based on an upgrade signal, the general processing module switches execution from the first software to the second software, evaluates proper operation of the general processing module, and switches execution back to the first software from the second software when proper operation of the general processing module using the second software is not detected. A communications module, in electrical communication with the general processing module, stores third software and executes the third software. The general processing module receives fourth software from the external port and replaces the third software with the fourth software.

In other features, the handheld diabetes management device includes a wireless control module in electrical communication with the communications module. The general processing module selectively updates operating instructions of the wireless control module via the communications module. The general processing module replaces previous operating instructions of the wireless control module with updated operating instructions via the communications module.

In further features, when proper operation of the wireless control module using the updated operating instructions is not detected, the general processing module replaces the updated operating instructions of the wireless control module with the previous operating instructions via the communications module. When proper operation of the communications module using the fourth software is not detected, the general processing module replaces the fourth software with the third software. The general processing module uploads user information to a remote host via the external port prior to switching execution of the general processing module from the first software to the second software.

In still other features, the general processing module stores the user information in one or more databases. The general processing module deletes the one or more databases when proper operation of the general processing module using the second software is detected. The processing module receives updated databases including the user information from the remote host. The general processing module deletes the first software when proper operation of the general processing module using the second software is detected. The second software is self-contained such that the general processing module executes the second software independent of any portion of the first software.

A method is defined for operating a handheld diabetes management device to implement a failsafe firmware upgrading protocol to maximize availability. The method includes storing first software in a nonvolatile memory, receiving second software from an external port, writing the second software to the nonvolatile memory, and selectively receiving an upgrade signal. Based on the upgrade signal, the method switches execution from the first software to the second software, evaluates proper operation of the second software, and switches execution back to the first software from the second software when proper operation of second software is not detected. The method further includes receiving third software from the external port and replacing fourth software of a communications module with the third software.

In other features, the method includes selectively updating operating instructions of a wireless control module via the communications module. The method further includes replacing previous operating instructions of the wireless control module with updated operating instructions via the communications module. The method further includes evaluating proper operation of the wireless control module using the updated operating instructions. When proper operation of the wireless control module using the updated operating instructions is not detected, the method replaces the updated operating instructions of the wireless control module with the previous operating instructions via the communications module.

In further features, the method includes, when proper operation of the communications module using the third software is not detected, replacing the third software with the fourth software. The method further includes uploading user information to a remote host via the external port prior to switching execution from the first software to the second software. The method further includes storing the user information in one or more databases and deleting the one or more databases when proper operation of the second software is detected.

In still other features, the method further includes receiving updated databases including the user information from the remote host. The method further includes deleting the first software when proper operation of the second software is detected. The second software is self-contained such that execution of the second software is independent of any portion of the first software.

What is claimed is:

1. A handheld diabetes management device that implements a failsafe firmware upgrading protocol to reduce risk of device downtime and to reduce required user interaction, the handheld diabetes management device comprising:
a nonvolatile memory;
a general processing module in electrical communication with the nonvolatile memory, wherein the general processing module executes first software from the nonvolatile memory;
an external port in electrical communication with the general processing module,
wherein the general processing module receives second software from the external port and writes the second software to the nonvolatile memory, and
wherein based on an upgrade signal, the general processing module:
switches execution from the first software to the second software,
evaluates proper operation of the general processing module, and
switches execution back to the first software from the second software when proper operation of the general processing module using the second software is not detected; and
a communications module in electrical communication with the general processing module,
wherein the communications module stores third software and executes the third software, and
wherein the general processing module receives fourth software from the external port and replaces the third software with the fourth software.

2. The handheld diabetes management device of claim 1 further comprising a wireless control module in electrical communication with the communications module, wherein the general processing module selectively updates operating instructions of the wireless control module via the communications module.

3. The handheld diabetes management device of claim 2 wherein the general processing module replaces previous operating instructions of the wireless control module with updated operating instructions via the communications module.

4. The handheld diabetes management device of claim 3 wherein, when proper operation of the wireless control module using the updated operating instructions is not detected, the general processing module replaces the updated operating instructions of the wireless control module with the previous operating instructions via the communications module.

5. The handheld diabetes management device of claim 1 wherein, when proper operation of the communications module using the fourth software is not detected, the general processing module replaces the fourth software with the third software.

6. The handheld diabetes management device of claim 1 wherein the general processing module uploads user information to a remote host via the external port prior to switching execution of the general processing module from the first software to the second software.

7. The handheld diabetes management device of claim 6 wherein the general processing module stores the user information in one or more databases, and wherein the general processing module deletes the one or more databases when proper operation of the general processing module using the second software is detected.

8. The handheld diabetes management device of claim 7 wherein the processing module receives updated databases including the user information from the remote host.

9. The handheld diabetes management device of claim 1 wherein the general processing module deletes the first software when proper operation of the general processing module using the second software is detected.

10. The handheld diabetes management device of claim 1 wherein the second software is self-contained such that the general processing module executes the second software independent of any portion of the first software.

11. A method of operating a handheld diabetes management device to implement a failsafe firmware upgrading protocol to reduce risk of device downtime and to reduce required user interaction, the method comprising:
storing first software in a nonvolatile memory;
receiving second software from an external port;
writing the second software to the nonvolatile memory;
selectively receiving an upgrade signal and, based on the upgrade signal:
switching execution from the first software to the second software,
evaluating proper operation of the second software, and
switching execution back to the first software from the second software when proper operation of second software is not detected;
receiving third software from the external port; and
replacing fourth software of a communications module with the third software.

12. The method of claim 11 further comprising selectively updating operating instructions of a wireless control module via the communications module.

13. The method of claim 12 further comprising replacing previous operating instructions of the wireless control module with updated operating instructions via the communications module.

14. The method of claim 13 further comprising:
evaluating proper operation of the wireless control module using the updated operating instructions; and
when proper operation of the wireless control module using the updated operating instructions is not detected, replacing the updated operating instructions of the wireless control module with the previous operating instructions via the communications module.

15. The method of claim 11 further comprising, when proper operation of the communications module using the third software is not detected, replacing the third software with the fourth software.

16. The method of claim 11 further comprising uploading user information to a remote host via the external port prior to switching execution from the first software to the second software.

17. The method of claim 16 further comprising:
storing the user information in one or more databases; and
deleting the one or more databases when proper operation of the second software is detected.

18. The method of claim 17 further comprising receiving updated databases including the user information from the remote host.

19. The method of claim 11 further comprising deleting the first software when proper operation of the second software is detected.

20. The method of claim 11 wherein the second software is self-contained such that execution of the second software is independent of any portion of the first software.
